(19) United States
(12) Patent Application Publication
(10) Pub. No.: US 2008/0162707 A1
(43) Pub. Date: Jul. 3, 2008

(54) Time Based Permissioning

(75) Inventors: Robert L. Beck, Seattle, WA (US); Kevin Sullivan, Seattle, WA (US); Peter Loveless, Seattle, WA (US)

Correspondence Address: LEE & HAYES PLLC, 421 W RIVERSIDE AVENUE SUITE 500, SPOKANE, WA, 99201, US

(73) Assignee: MICROSOFT CORPORATION, Redmond, WA (US)

(21) Appl. No.: 11/617,556

(22) Filed: Dec. 28, 2006

(51) Int. Cl. G06F 15/16

(52) U.S. Cl. 709/229

(57) ABSTRACT

A user object is created via an administrator interface. The user object indicates access to system resources for an individual user. The user object is provided a permission time period specifying when a user associated with the object can access the system resource with a computing device. To access the resource, the computing device would generate a request or attempt to access the system resource. In response the request or access attempt, the user object is read to determine when the user of the computing device can access the resource. The user of the computing device could be provided access to the resource during the time period and denied access to the resource outside of the time period.

### BACKGROUND

System administrators regularly create system resources such as user accounts, system policies, network accessible shares and host level services. Generally the system administrator is responsible for managing, disabling and removing the resources when they are no longer needed. As part of managing the resources, the administrator must assign resources to users for periodic access to the resources. Resource management can also require extensive record keeping and administrative scripts resulting in significant administrative overhead.

Enabling system resources at a different time than when the resource is assigned is a notable issue. A scenario that demonstrates this issue occurs when an administrator is required to create a user account that must be enabled over the course of a weekend, or otherwise outside of the administrator's normal operating hours. One solution to the problem, which does not require development of system administrative resources, such as scripts or special application software, is for the administrator to work on the weekend to complete the required task. Alternatively the administrator could create a new account prior to leaving for the weekend. Neither option provides a manageable or secure solution.

### SUMMARY

A user object is created via an administrator interface. The user object specifies a permission time period in which a client device associated with the object can access a system resource. To access the resource, the client device would generate a request or attempt to access the resource. The user object is read by a computing device to determine when the client device can access the resource. The resource would be provided with an indication that would allow the client device access to the resource during the allowable time period, and would deny access to the resource outside of the allowable time period. Thus a system is provided with a reduced overhead and secure method to access system resources.

### BRIEF DESCRIPTION OF THE DRAWINGS

The detailed description is described with reference to the accompanying figures. In the figures, the left most digit(s) of a reference number identifies the figure in which the reference number first appears. The same numbers are used throughout the drawings to reference like features and components:

FIG. 1 is a simplified diagram of a system for requesting permission to access system resources.

FIG. 2 is simplified block diagram illustrating a server providing time based permissioning.

FIG. 3 is a flow diagram of a method for time based permissioning.

FIG. 4 is an exemplary interface to enable a user to initiate time based permissioning.

### DETAILED DESCRIPTION

A system for requesting permission to access system resources in a time based manner is described. The system includes embodiments that provide for granting permission to one or more client devices, or users of the client devices, to access the system resources at a pre-defined time.

While aspects of described systems and methods for a time based permissioning can be implemented in any number of different environments, and/or configurations, the system and methods are described in the context of the following exemplary system architecture(s).

### An Exemplary System

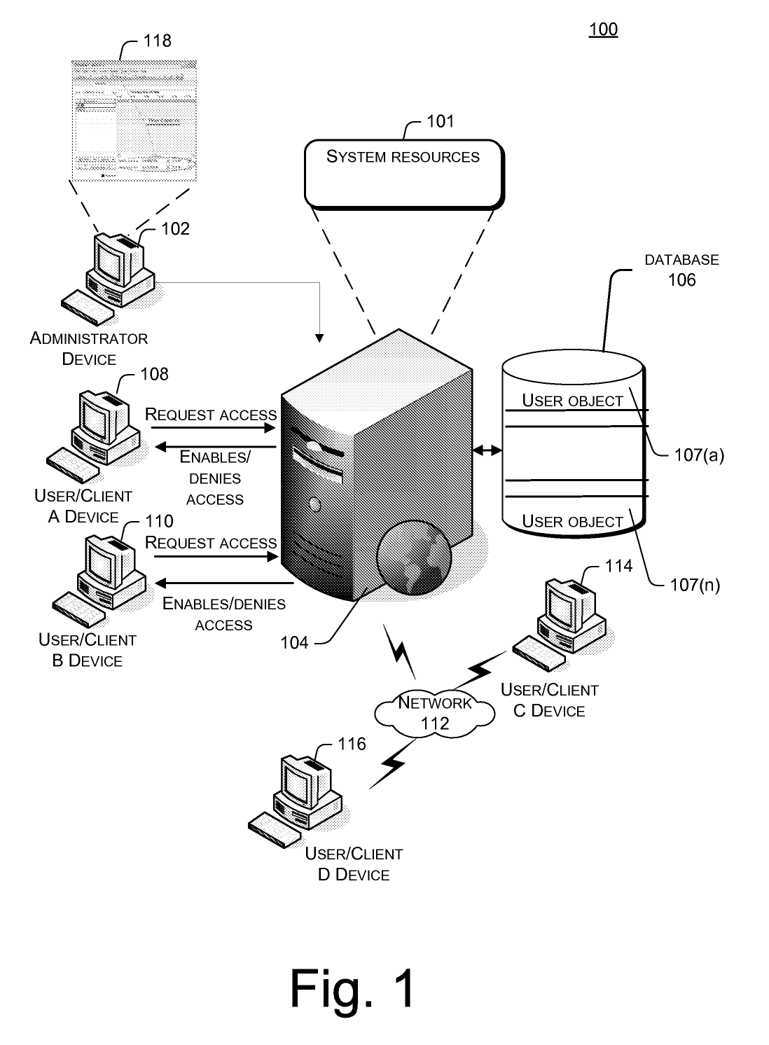

FIG. 1 illustrates a system 100 for requesting permission to access system resources 101. The system 100 includes an administrator device 102, a server 104 and a database 106 containing user objects 107(a-n). Server 104 may be directly coupled to a user/client A device 108 and a user/client B device 110, and/or be coupled through a network 112 to a user/client C 114 device or a user/client D device 116. The client devices 108, 110, 114 and 116 may be implemented any number of ways including, for example, a general purpose computing device, a server, a laptop, cell phone, portable desktop assistant and/or so on.

Administrator device 102 may be used to create a plurality of user objects 107(a-n) collectively having a set of policies associated with accessing allowance of system resources 101 (also referred to herein as a share/account). The user objects 107(a-n) may be created by the server 104 based on data received from the administrator device 102 through an administrator user interface 118. Server 104 and administrator device 102 may be, for example, general purpose computing devices, servers, server farms, clusters, mainframes, etc.

The user objects 107(a-n) may be stored in database 106. The database 106 may be disposed in a persistent system memory within server 104. The user objects 107(a-n) comprises data related to when one or more users can access the system resources 101, examples of which include the shares/accounts for the one or more users. The system resources 101 may also include for example, user accounts, system policies, network accessible shares, host level services, application programs, file shares, etc.

Server 104 may receive a request for accessing the system resources 101 present in the server 104. The request may be received directly from one or more users/clients 108-116, examples of which include a user/client device A 108 and a user/client device B 110. The user/client device A 108 and user/client device B 110 may submit requests to server 104 for accessing the system resources 101 or may attempt to directly access the system resource 101.

In one implementation, server 104 in response to the received requests may query database 106 to identify the user objects 107(a-n) associated with the user/client device A 108 and the user/client device B 110. In another implementation, the server 104 queries the database 106 using an application program being executed on server 104. The user objects 107(a-n) may be analyzed by the server 104 to determine whether the user/client device A 108 and the user/client B device 110 is allowed access to the system resources 101 at the specific time of requests. Server 104 may allow or deny access to the user/client device A 108 and the user/client device B 110 once the respective user objects 107(a-n) are analyzed.

In another exemplary implementation, an application program running on server 104 may monitor a permission time period for each of the user devices, i.e. the access time period allowed for the user devices, connected to the server 104 to access system resources 101. Once the permission time periods of the user devices are identified, the application program updates the user objects 107(a-n) to indicate enablement or disablement of the system resources 101 and sends a signal to an application being executed on a user device to enable the user of the device access to the resource.

In yet another implementation, the application program may be executed by the server 104 simultaneously when other applications used by the user devices are being executed. For example, one or more users of the devices may request access to a plurality of applications being run by the server 104. Server 104 may employ an application program to monitor the access provided to the users and simultaneously run the applications accessed by users. In one implementation, the server 104 may disable the use of the application program once one or more user objects 107(a-n) is disabled or indicates disablement.

In one implementation, the access allowance for the user/client device A 108 and the user/client device B 110 may be defined in a single user object. In an exemplary implementation, the user/client device A 108 and the user/client device B 110 may request access of the system resources 101 at a same time period. Server 104 verifies with the user object in the database to identify which one of the users have the access at that particular time period. The access may be allowed to either the user/client device A 108 or user/client device B 110 based on a preset policy for the respective user objects 107(a-n).

For example, one or more students may request access to a file through a server 104 at the same time period in an institution. Server 104 may check with a database 106 to identify one or more user objects 107(a-n) associated with the students. The user objects 107(a-n) may be analyzed to identify the students allowed to access the file at that particular time period. The user objects 107(a-n) may define for example, which of the students are allowed access to the file at that particular time period and which others are allowed access to the file at a different time period. Once the access allowance for each student is determined from the objects 107(a-n), the server 104 may deny or allow access to each student to the file.

In one implementation, the user objects 107(a-n) may be defined in such a way that the user objects 107(a-n) may be created just prior to the time period allotted for accessing the system resources 101. In yet another implementation, the user objects 107(a-n) may include a characteristic that enables the user objects 107(a-n) to be automatically deleted once the time period for accessing the resource has lapsed. For example, two users may wish to prepare a project using an application program. The users may be allotted with different time periods for working on the project with the program by an administrator 102. A set of user objects 107(a-n) may be created by the administrator 102, the user objects 107(a-n) may include the time periods for accessing the project by the respective user devices and some other specific characteristics. The specific characteristics may include, for example, automatically deleting the user object associated with a primary user device once the time period of the primary user device has elapsed and automatically creating the user object associated with a secondary user device prior to commencement of the time period for use of the secondary device.

In another implementation, the user objects 107(a-n) may allow the user of the user devices to access one or more system resources 101 simultaneously. For example, a user object may be created by an administrator device 102 such that a user of the user device associated with the user object is granted permission to access multiple user accounts at the same time. In another implementation, the server 104 upon receipt of a request from the user, employs the application program to query the database 106 to enable and/or disable the system resources 101. For example, an employee may access a corporate network to work on a project during a specific time period and request access after a time period of inactivity. In such a case, an administrator device 102 using an application program may disable a user object (by updating the user object to indicate disablement) associated with the employee once the specific time period elapses. The administrator device 102 may allow the employee to access the corporate network upon making request for access after the time period of inactivity. The accessibility is allowed by enabling the user object (by updating the user object to indicate enablement). In yet another implementation, the user object may be enabled during the permission time period of the user device.

In one exemplary implementation, the server 104 may be connected to a plurality of user devices like a user/client device C 114 and a user/client device D 116 via a network 104 (e.g., the internet or an intranet). Examples of such networks include, but are not limited to, Local Area Network (LAN), Wide Area Network (WAN). Further, a network may be a wireless or a wired network, or a combination thereof. For example, a plurality of students may wish to engage in a chat network through the internet at a particular time frame. In such a case, an administrator device 102 may have allotted different time period for students to access the internet. Hence, a first student and a second student may be allowed an access to the internet at the particular time frame. Whereas, a third student may be allocated a different time period for access resulting in a denial of the access.

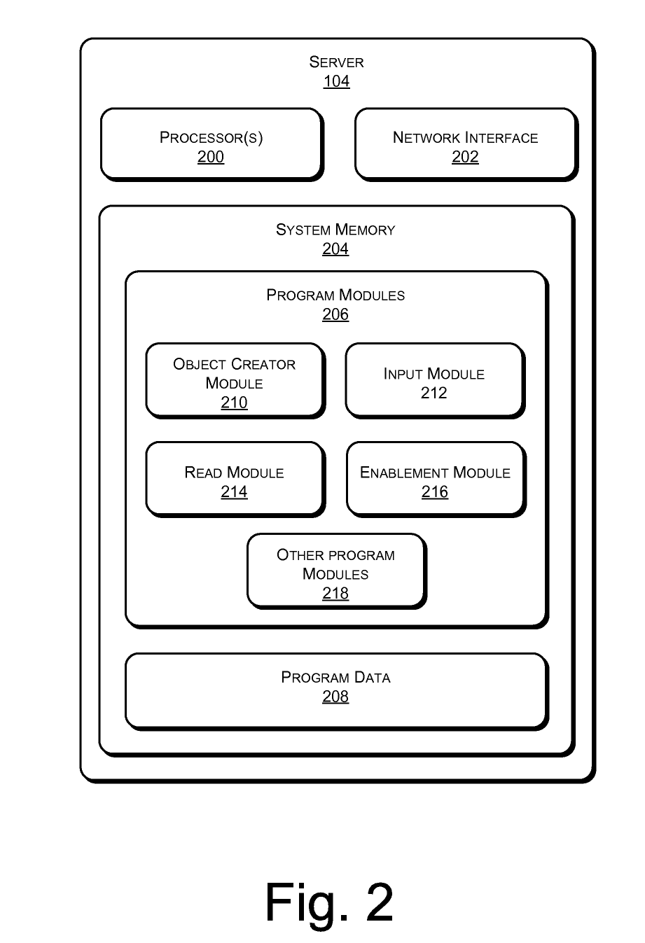

FIG. 2 illustrates server 104 for time permissioning, according to one embodiment. The exemplary server 104 is described with reference to FIG. 1. Server 104 includes a processor(s) 200, a network interface 202 and a system memory 204. Processor(s) 200 may be a microprocessor, microcomputer, microcontroller, digital signal processor, etc. System memory 204 may be persistent and include, for example, a volatile random access memory (e.g., RAM) and a non-volatile read-only memory (e.g., ROM, flash memory, etc.). In one implementation, the system memory 204 may be located remote to the server 104. System memory 204 comprises program modules 206 and program data 208. Program modules 206 may include, for example, an object creator module 210, an input module 212, a read module 214, an enablement module 216 and other program modules 218. Examples of program modules 206 include an operating system (OS) that provide a runtime environment.

Object creator module 210 creates a plurality of user objects 107(a-n) based on inputs received from an administrator device 102. The user objects 107(a-n) specify a permission time period within which users of the user devices can access the system resources 101 such as shares/accounts. The user objects 107(a-n) may be stored in a database 106 (FIG. 1). In one implementation, the user objects 107(a-n) may be stored with the program data 208. One or more user devices may send a request to the server 104 to be allowed access to system resources 101. The request may be received by the input module 212. For example, a user/client device A 108 and a user/client device B 110 may request an access to an application program to the server 104. In one implementation, the request may be entered using a user interfaces (not shown) on each of user devices 108-116. Such request may then be received via the network interface 202 from one or more user devices connected to the server 104 over a network 112.

Once the request is received, the input module 212 may analyze the request to identify user's access choice. The user's access choice may be, for example, a user's preference of one or more system resources 101 from a plurality of system resources 101. The identified user's choice is provided to the read module 214.

Read module 214 reviews the user's choice and checks with the database 106 to identify the user object associated with the identified user's choice for a given user device. The identified user object is examined by the read module 214 to understand and decide whether the user device will be allowed to access the system resources 101 at a time of request. Once the read module 214 arrives at a decision to either allow or not allow the user device to access the system resources 101, the read module 214 triggers the enablement module 216 to implement the decision. Enablement module 216 may enable or disable the system resources 101 based on a permission time period defined in the user object by a process, for example, of transmitting a signal to a controller for the system resource, or enabling/disabling an application that manages the system resource.

In one possible implementation, a process of identification of the user's choice and review of the user's choice is implemented by a combination module upon receipt of instructions from the object creator module 210. The combination module can be configured to perform functions of the input module 212 and the read module 214. Alternately, the combination module can be a combination of the input module 212 and the read module 214. The combination module may be included in the other program modules 218.

For example, the request to access the system resources 101 such as share/accounts may be received by a combination module. The combination module can then analyze the request to identify the user device's choice. The choice is then reviewed to identify the user object associated with the choice. The user object is further analyzed to arrive at a decision as to whether a user of a user device will be allowed to access the share/accounts.

### An Exemplary Method

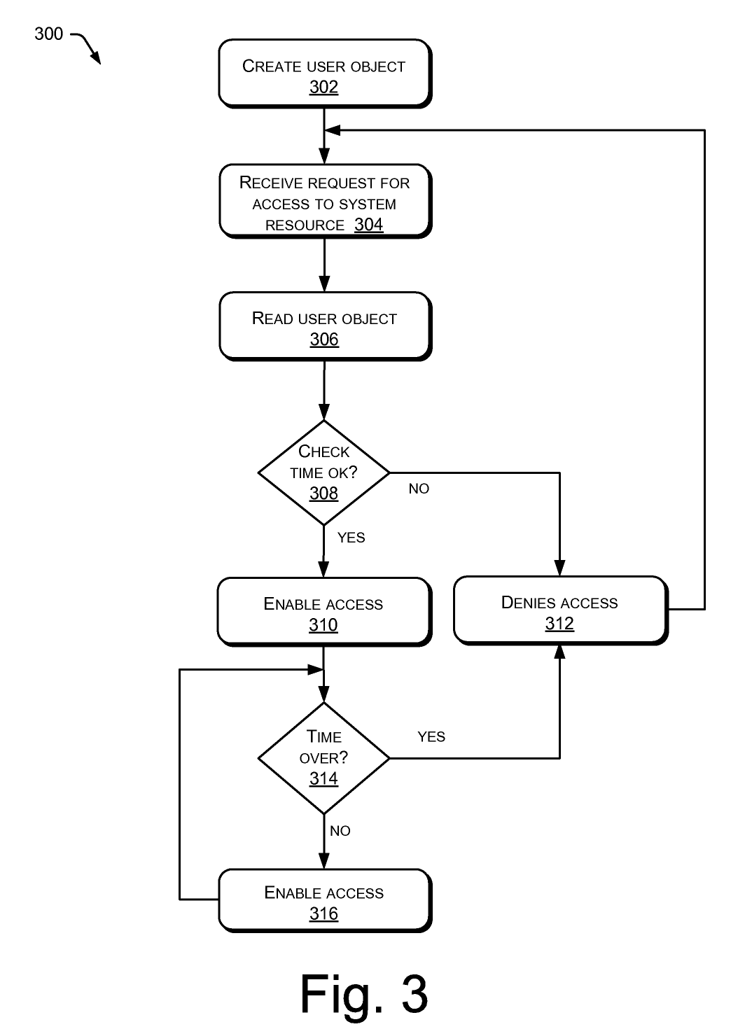

Exemplary method for time based permissioning is described with reference to FIG. 3. These exemplary methods may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 3 illustrates an exemplary method 300 for time based permissioning and is described with reference to the system 100 for requesting permission to access system resources 101 as shown in FIGS. 1-2. The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or combination thereof.

At block 302, a user object for accessing system resources 101 such as a network accessible share, user account or host service, is created. For example, a server 104 can receive input data for creating a user object from an administrator device 102 using object creator module 210. The administrator device 102 may receive the input data from a user via an administrator interface 118. Once the input data is received by an object creator module 210, the object creator module 210 creates the user object and stores it in database 106. The user object defines a permission time period for accessing system resources 101 by a user. In one implementation, the user object is created prior to commencement of the time period for accessing the system resource. For example, an object creator module 210 creates a user object just prior to the start of the permission time period of a user for accessing a network, such as a corporate network. In one exemplary embodiment, the user object may provide access for one or more networks.

At block 304, a request for access to the system resource, such as a network share may be received by a server, such as by an input module 212 of the server 104. Alternatively a user of a client device could attempt to directly access the system resource. The input module examines the request/access attempt to identify the resource. For example, a server 104 may receive a request for accessing a system resource from a user/client device A 108 or user/client device B 110. An input module 212 of the server 104 may review the request to identify information of the system resource requested by the user/client A 108 or user/client B 110. The information is then sent to a read module 214 to identify a user object associated with any of the user/client device A 108 or user/client device B 110 (or user of device A 108 or device B 110).

At block 306, the user object is read to identify a permission time period allotted for accessing the system resources 101. For example, a read module 214 reviews user objects 107(a-n) and identifies a permission time period allotted for a user to access system resources 101.

At block 308, a determination is made whether the permission time period specified by the read user object complies with a time of request of the user device. If the permission time period complies with the time of request (i.e., “yes” path from block 308), the user device is granted access to the system resources 101, or access is enabled (block 310). If the permission time period does not comply with the time of request (i.e., “no” path from block 308), the user device is denied access to the system resources 101, or access is disabled (block 312).

For example, the read module 214 checks the user object associated with an employee, to identify whether the permission time period for accessing a network, such as a corporate network, matches with the time of request of the employee. If the read module 214 identifies that the permission time period does not match with the time of request, then the employee (via a client device) is not allowed access to the network by an enablement module 216. Alternately, if the permission time period matches with the time of request, the employee is allowed an access to the network by the enablement module 216.

At block 314, a determination is made whether the permission time period for accessing the system resources 101 has elapsed. If the permission time period has elapsed (i.e., “yes” path from block 314), then method 300 moves to block 312 and the user device is denied access to the system resources 101. If the permission time period has not elapsed (i.e., “no” path from block 314), then the method 300 continues to block 316 and the user device is allowed access to the system. This process of checking continues until the permission time period elapses.

For example, the enablement module 216 continuously checks whether the permission time period for an employee to access a network, such as corporate network, has elapsed. If in case the permission time period has elapsed, the employee will not be allowed to access the corporate network any further and the employee's user device may be, for example, disconnected from the corporate network. Alternately, if the permission time period has not elapsed, the employee may be allowed a continued access to the network. Enablement module 216 continues to check the permission time period until the permission time period elapses.

### Exemplary User Interface

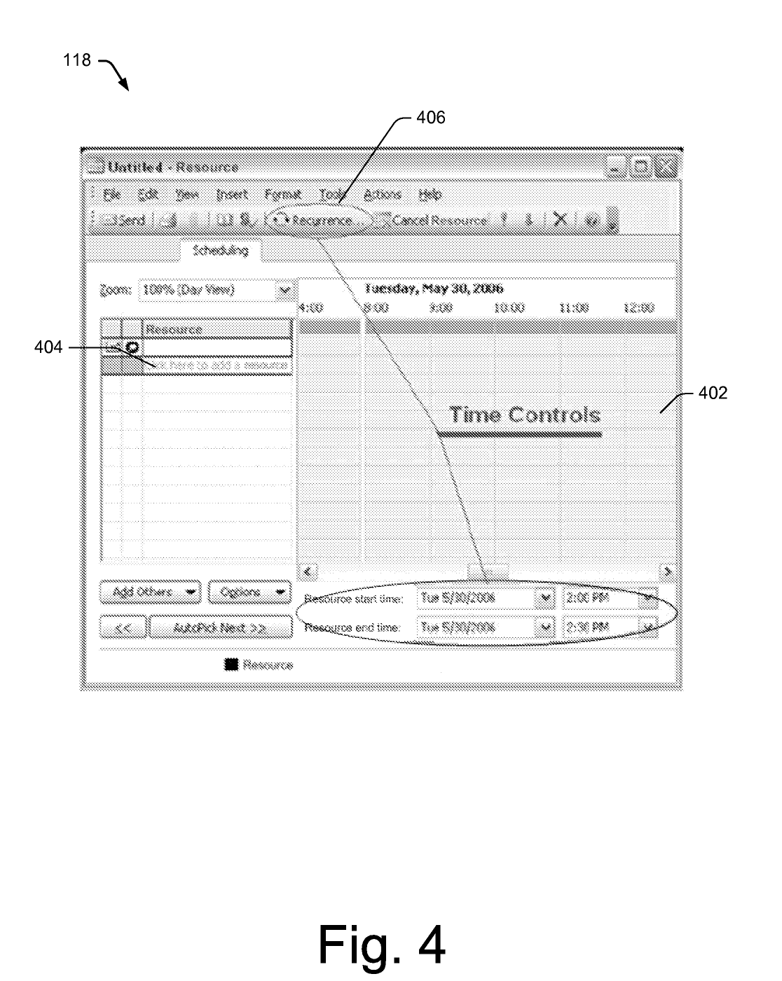

FIG. 4 illustrates an exemplary user interface (UI) 118 to enable a user to initiate a time based permissioning. For purposes of exemplary description and illustration, the features of UI 400 are described with respect to components of FIGS. 1-2.

In this example, UI 400 represents a system resource management application. UI 400 includes, for example, a system resource scheduling area 402 for an administrator to input into administrator device 102 the schedule for accessing the resources by a plurality of users. The schedule may include, for example, time period and date for accessing the resources. UI 400 also includes a resource adding area 404 for the administration to add the resources, such as network shares, user accounts, administrator accounts, local security policies, etc. For example, an administrator device 102 may create a user object associated with the accessing of a system resource such as a corporate network from system resource 101, in a resource adding area 404. The time period and the date for accessing the corporate network by one or more employees may be scheduled by the administrator device 102 in a resource scheduling area 402. In such a case, the employee can access the corporate network at their respective time period. In one implementation, the user object may be automatically created once the time period for accessing the corporate network starts.

UI 400 also includes a resource recurrence scheduling portion 406 that facilitates the administrator to define a permission time period to access resources by one or more user devices (or users of the user devices) and the permission time period may reoccur. For example, an employee may be accessing a corporate network on a few preferred days a week. Administrator device 102 may create a user object specifying the permission time period for accessing the corporate network for the preferred days of a week and define that the user object may reoccur for the subsequent weeks of the month. In one implementation, the user object may be automatically removed once the permission time period elapses.

In another implementation, the user object may be defined in such a way as to automatically indicate disablement or being disabled, (e.g. not being allowed to be accessed) once an initial permission time period elapses. The user object may be defined to indicate enablement once the same user device or another user device (or user of the user device) requests access during the subsequent permission time period. For example, a project may be prepared by one or more employees working at multiple schedules with a time off. Administrator device 102 may create a user object for accessing a corporate network so that the user object may automatically indicate disablement once the time off starts and indicate enablement once the time off elapses.

In yet another implementation, the user object may be deleted once the first permission time period elapses and be automatically created once a same user device or another user requests access prior to start of a second permission time period. For example, the administrator device 102 may create a user object specifying a set of attributes that may enable the user object to be automatically deleted once an employee has completed his initial time period of access to a corporate network. The administrator device may specify a set of attributes that may enable to the user object to be automatically created once the employee's client device sends a request to resume the access before a subsequent time period commences.

### CONCLUSION

Although embodiments of a system for requesting permission to access system resources have been described in language specific to structural features and/or methods, it is to be understood that the subject of the appended claims is not necessarily limited to the specific features or methods described. Rather, the specific features and methods are disclosed as exemplary implementations of a system for requesting permission to access system resources.

1. A method comprising:
creating a user object that specifies a permission time period when a client device associated with the object can access a system resource;
receiving request for access by the client device to the system resource;
in response to the request, reading the user object to determine when the client device can access the system resource; and
enabling the client device access to the system resource during the time period and denying the client device access to the system resource outside of the time period.

2. The method as recited in claim 1, wherein the receiving and reading are performed by a server computer coupled with a network.

3. The method as recited in claim 1, wherein the user object is stored in a database stored in persistent memory of the computing device.

4. The method as recited in claim 1, wherein the user object comprises at least one of characteristics selected from the group comprising: being created immediately prior to a start of the permission time period, enables access to one or more system resources, disables access to one or more system resources, or is automatically deleted after access.

5. The method as recited in claim 1, further comprising indicating resource enablement by the user object during the permission time period or indicating resource disablement by the object outside the time period.

6. The method as recited in claim 1 wherein the user object is created via an administrator interface using an administrator computer coupled with the computing device.

7. The method of claim 1, further comprising one of enabling or disabling the system resource with an application program, and accessing with the application program, the user object to determine whether to enable or disable the system resource.

8. The method of claim 7, wherein the application program that monitors access is executed by the computing device while other applications are simultaneously being executed by the computing device.

9. One or more computer readable media having computer-executable instructions, which when executed by a processor, perform acts comprising:
creating a user object that specifies a permission time period when a user of a client device associated with the object can access a system resource, wherein the system resource is selected from a group of system resources comprising user accounts, network accessible shares and host level services;
storing the user object in a memory;
receiving a request for access by the client device to the system resource;
in response to the request, reading the user object from memory to determine when the user of the client device can access the system resource; and
generating an indication that enables the user of the client device access to the system resource only during the permission time period.

10. The computer readable medium of claim 9, wherein said user object is created via an administrator interface, and wherein the request is received by a computing device coupled with a network.

11. The computer readable medium of claim 9, wherein the user object is stored in a database in persistent memory, and wherein the memory is disposed within a server.

12. The computer readable medium of claim 9, wherein the user object comprises at least one of characteristics selected from the group of characteristics comprising: being created immediately prior to a start of the permission time period, enables access to one or more system resources, disables access to one or more system resources, or is automatically deleted after access.

13. The computer readable medium of claim 9, further comprising enabling the object during the permission time period or disabling the object outside the time period.

14. The computer readable medium of claim 9, further comprising disabling the use of an application program when the object is disabled.

15. The computer readable medium of claim 14, further comprising enabling or disabling the system resource with the application program, and accessing with the application program, the user object to determine whether to enable or disable the system resource.

16. The computer readable medium of claim 15, wherein the application program that monitors access is executed by the computing device while other applications are simultaneously being executed by the computing device.

17. An apparatus comprising:
an object creator module to create via an administrator interface a user object that indicates a permission time period when a client computer associated with the user object can access a system resource;
a read module that reads the user object to determine when the client computer can access the system resource; and
an enablement module to provide an indication to enable the client computer access to the system resource only during the indicated permission time period.

18. The apparatus as recited in claim 17 wherein the system resource comprises a network share, a host level service or a user account.

19. The apparatus as recited in claim 18, wherein said system resource comprises an application program; and wherein said enablement module provides an indication to deny use of the application program outside of the permission time period.

20. The apparatus of claim 17, further comprising an application module that accesses the user object to determine whether to enable or disable the system resource.
